(19) United States
(12) Patent Application Publication
(10) Pub. No.: US 2013/0110887 A1
(43) Pub. Date: May 2, 2013

(54) Battery Charger as a Centralized Personal Data Storage System

(71) Applicant: Yang Pan, Singapore (SG)

(72) Inventor: Yang Pan, Singapore (SG)

(21) Appl. No.: 13/281,435

(22) Filed: Oct. 26, 2011

(51) Int. Cl. G06F 17/30; G06F 1/26

(52) U.S. Cl. 707/821; 713/300; 707/E17.001

(57) ABSTRACT

An intelligent battery charger comprises functional units including a file storage system, a controller and a communication device. The intelligent charger can be used as a centralized data storage system for personal electronic devices. When a personal electronic device is connected to the intelligent battery charger for charging the battery, data files are transferred from the electronic device to the charger or vice versa. The data files may be stored in different electronic devices according to a status file that includes storage locations of each data file. The intelligent charger may also be used to connect to a media delivery unit such as a HiFi audio system or a digital TV system as an external storage unit.

### CROSS-REFERENCE TO RELATED APPLICATIONS

Not applicable.

### BACKGROUND

1. Field of Invention

This invention relates generally to a storage system. More specifically, the invention describes a system and method for storing data files in a battery charger and in multiple personal electronic devices.

2. Description of Prior Art

Portable electronic devices, such as smart phones, laptop computers, handheld media players and tablet computers, are often used by individuals on a personal base. It is not uncommon for a user to possess multiple portable electronic devices. Often, these portable electronic devices store media assets for use by their users. Media assets are typically downloaded from a host computer by way of a data link such as a USB or a FIREWIRE. A centralized media database is typically stored in the host computer. A media database of a portable electronic device is synchronized to the centralized media database when the device is connected to the host computer.

As portable electronic devices become more versatile and more interactive, it is advantageous to have simpler ways to exchange media assets and other type of data files. Thus, there is a need to facilitate data exchange among the portable electronic devices.

### SUMMARY OF THE INVENTION

It is an objective of the present invention to provide a system and method for synchronizing media asset databases of different portable electronic devices through a centralized database in a commonly used battery charger.

It is another objective of the present invention to provide a method to synchronize a database in an electronic device and a database in the battery charger while a rechargeable battery of the electronic device is being charged by the battery charger.

It is further another objective of the present invention to provide a method to synchronize a database in an electronic device and a database in the battery charger according to a status file while a rechargeable battery of the electronic device is being charged by the battery charger.

It is yet another objective of the present invention to provide a method of delivering a media asset to a user by using a media delivery unit connected to the battery charger including a media asset database.

It is still another objective of the present invention to provide a method of utilizing the battery charger as a key storage node connected to a network for other electronic devices to access the data files stored in the battery charger.

An exemplary system comprises multiple personal devices and a shared battery charger. The personal devices may include personal computers such as laptop computers and tablet computers. The personal devices may also include smart phones and handheld media players. Each of the personal devices includes a processor, a file storage system, a connector for a power link, a communication device for a data link and a rechargeable battery. The battery charger includes a conventional battery charger, a file storage system, a connector for the power link and a communication device for the data link.

When an electronic device and the battery charger are connected, the power link and the data link are established. The power link is used to deliver the electrical power to charge the battery. The data link is used to transfer data files from the file storage system in the charger to the file storage system in the electronic device or vice versa.

According to one embodiment, the databases in the electronic devices are synchronized to the one in the charger. According to one implementation of the embodiment, the database in the battery charger is synchronized to a database in a personal computer. Databases in other electronic devices are synchronized to the one in the battery charger whenever anyone of the devices is connected to the battery charger for charging a rechargeable battery.

According to another embodiment, data files are transferred either from the battery charger to the connected electronic device or vice versa. By doing so, databases in electronic devices will be synchronized.

According to yet another embodiment, a status file includes storage locations for each of the selected data files for a user. The storage locations may be modified in an exemplary manner by a user using a personal computer or any of the electronic devices. The status file may be stored in the file storage system of the battery charger. When an electronic device is connected to the battery charger, data files in the electronic device is updated based upon the status file.

According to one aspect of the present invention, the data link is a wired connection.

According to another aspect of the present invention, the data link is a wireless connection.

According to yet another aspect of the present invention, some of electronic devices may be connectable to the battery charger through a network. The network may be the Internet. The network may also be a home network including a LAN or a PAN.

According to one aspect of the present invention, the battery charger may be connected to a media delivery unit such as, for example, a HiFi audio system or a digital TV system. A portable electronic device such as a smart phone may be used as a remote control device for the media delivery unit. The portable device with a synchronized database to the one in the battery charger may display a user interface including metadata of the user selectable media assets stored in the battery charger.

### BRIEF DESCRIPTION OF THE DRAWINGS

For a more complete understanding of the present invention and its various embodiments, and the advantages thereof, reference is now made to the following description taken in conjunction with the accompanying drawings, in which:

FIG. 1 is a schematic diagram illustrating an exemplary system including an electronic device and an intelligent battery charger with a power and a data link;

FIG. 2 is a schematic diagram illustrating functional blocks of an exemplary intelligent battery charger;

FIG. 3 is a schematic diagram illustrating an exemplary system including multiple electronic devices and the intelligent battery charger;

FIG. 4A is a schematic diagram illustrating a HiFi audio system as a media delivery unit connected to the intelligent battery charger with a media asset database;

FIG. 4B is a schematic diagram illustrating a digital TV system as a media delivery unit connected to the intelligent battery charger with a media asset database;

FIG. 5A is a flowchart illustrating an exemplary process that database in the electronic device is synchronized to the database in the intelligent battery charger;

FIG. 5B is a flowchart illustrating an exemplary process that databases in the electronic device and the one in the intelligent battery charger are synchronized;

FIG. 5C is a flowchart illustrating an exemplary process that the database in the intelligent battery charger is synchronized to the database in a personal computer followed by synchronization between the database in the electronic device and the one in the intelligent battery charger;

FIG. 6 is a flowchart illustrating the operation of an exemplary media delivery unit connected to the intelligent battery charger with a media asset database;

FIG. 7A is an exemplary status file indicating storage locations of multiple data files.

FIG. 7B is a flowchart illustrating a process that databases in the electronic devices and in the intelligent battery charger are synchronized based upon a status file;

FIG. 8 is a schematic diagram illustrating another embodiment that personal electronic devices may be connected to the intelligent battery charger through a network;

FIG. 9 is a schematic diagram illustrating another embodiment that personal electronic devices may be connected to the intelligent battery charger through a home network;

FIG. 10 is a schematic diagram illustrating another embodiment that the data link between the electronic device and the intelligent battery charger may be a short range wireless link;

FIG. 11 is a schematic diagram illustrating another embodiment that the both the power and the data links are wireless ones.

### DETAILED DESCRIPTION

References will now be made in detail to a few embodiments of the invention, examples of which are illustrated in the accompanying drawings. While the invention will be described in conjunction with the particular embodiments, it will be understood that it is not intended to limit the invention to the described embodiments. To the contrary, it is intended to cover alternatives, modifications, and equivalents as may be included within the spirit and scope of invention as defined by the appended claims.

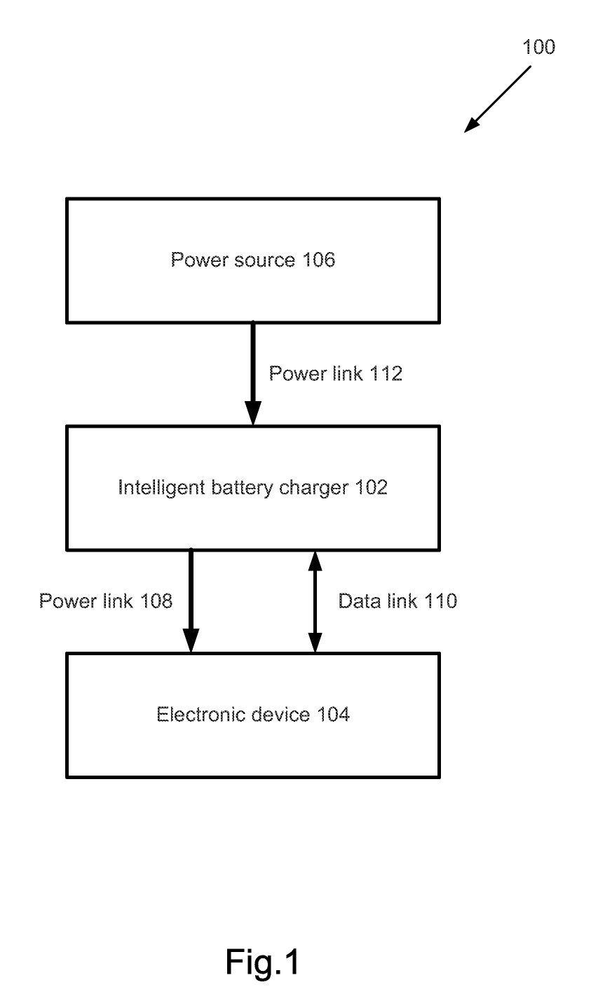

FIG. 1 is a schematic diagram illustrating an exemplary system 100. The system comprises an intelligent battery charger 102 and an electronic device 104. The intelligent battery charger 102 is connected to a power source 106. The power source is typically an AC power source connected to a power grid. The power source 106 may also be a DC power source including an alternative power source such as, for example, a solar panel. The electronic device 104 may be a personal computer such as a laptop computer or a tablet computer. The electronic device 104 may also be a smart phone or a handheld media player. The electronic device 104 may be any other portable electronic device such as, for example, a digital camera, a PDA and a game console. The intelligent battery charger 102 and the electronic device 104 are connected through both a power link 108 and a data link 110. The power link 108 is for delivering electrical power from the intelligent charger 102 to a rechargeable battery of the electronic device 104. The data link 110 is for exchanging of data files between the intelligent battery charger 102 and the electronic device 104. The data link 110 may be a USB type of connection or a FIREWIRE (IEEE 1394) type of connection in exemplary cases. The exchanging of data file may be controlled by a processor in the electronic device 104 and/or be controlled by a controller in the intelligent battery charger 102. The intelligent battery 102 is connected to the power source 106 through another power link 106.

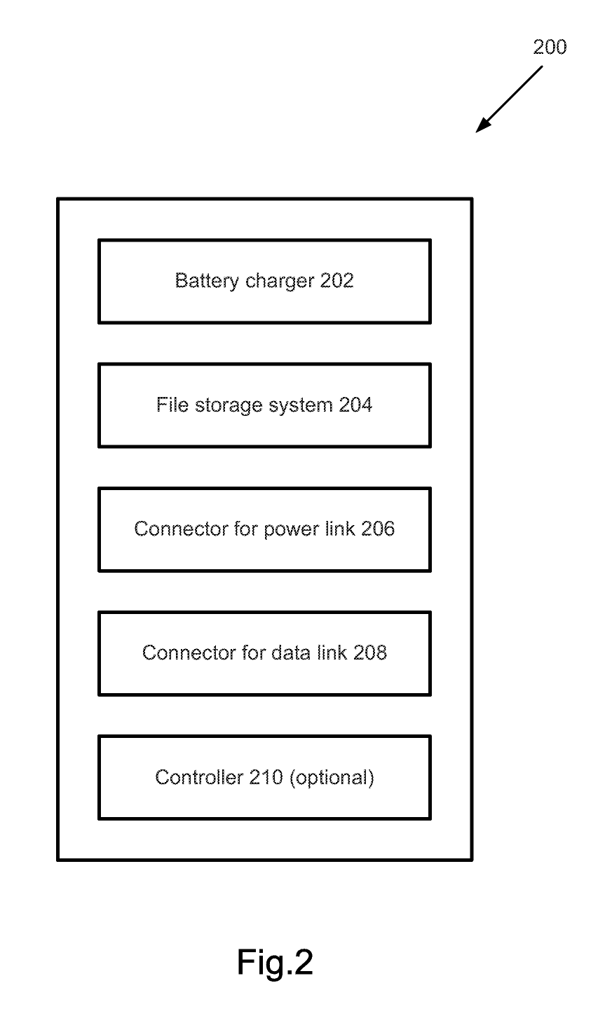

FIG. 2 is a schematic diagram illustrating functional blocks of an exemplary intelligent battery charger. The intelligent battery charger 200 includes a conventional battery charger 202 as known in the art. The intelligent battery charger 200 further includes a file storage system 204. The file storage system 204 may include one or multiple semiconductor flash memories. The file storage system 204 may also include a magnetic storage device such as a hard disk or an optical storage device.

The intelligent battery charger 200 further includes a connector 206 for the power link 108 and a connector 208 (communication device) for the data link 110. The connector 208 may be conformed to the USB or the IEEE 1394 standards. According to one aspect of the present invention, the intelligent battery charger 200 may be controlled by a processor from the connected electronic device. According to another aspect, the intelligent battery charger 200 may be controlled by a controller 210 in the charger. The controller 210 may be a microprocessor or microcontroller.

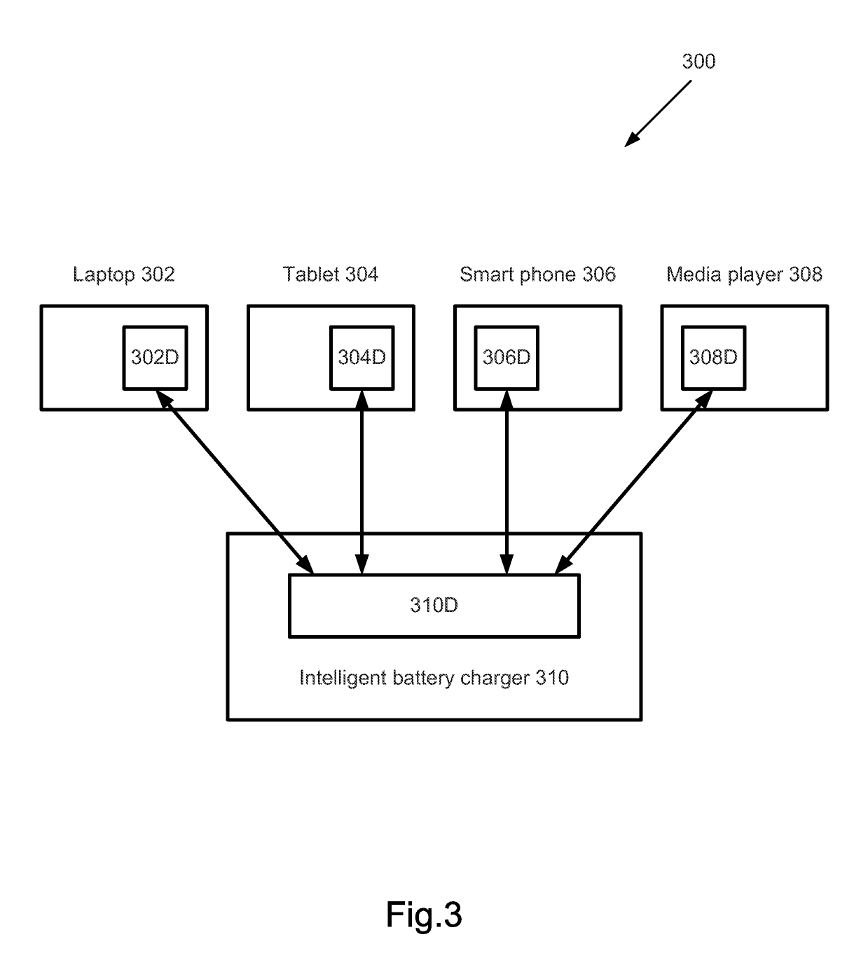

FIG. 3 is a schematic diagram illustrating an exemplary system 300 including multiple electronic devices and the intelligent battery charger. As shown in FIG. 3, the system 300 includes a laptop computer 302 with a file storage system 302D, a tablet computer with a file storage system 304D, a smart phone 306 with a file storage system 306D and a handheld media player 308 with a file storage system 308D. The system further comprises an intelligent battery charger 310 with a file storage system 310D. The file storage system of the intelligent battery charger 310 may include a centralized database. A database in each of the electronic devices is synchronized to the centralized database after the device is connected to the intelligent battery charger 310 for charging its rechargeable battery. Thus, the databases in 302D to 308D will be identical to the one in 310D after the synchronizations.

According to another aspect of the present invention, the database in 310D may be synchronized to a database in a personal computer at a first step of the system operations.

According to another aspect of the present invention, the synchronization may be bi-directional. After the database in a personal device is synchronized to the database in 310D, the data files in the database in the personal device which have not been stored in the intelligent battery charger will be transferred from the device to the database 310D. Therefore, databases in the device 302, 304, 306 and 308 are synchronized.

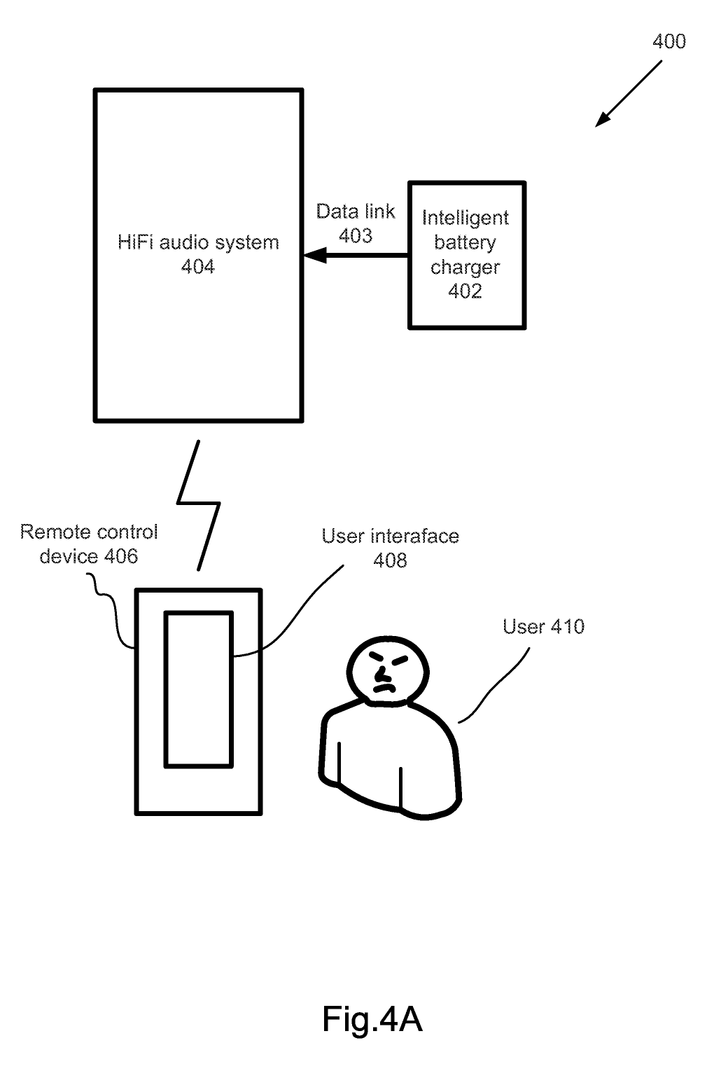

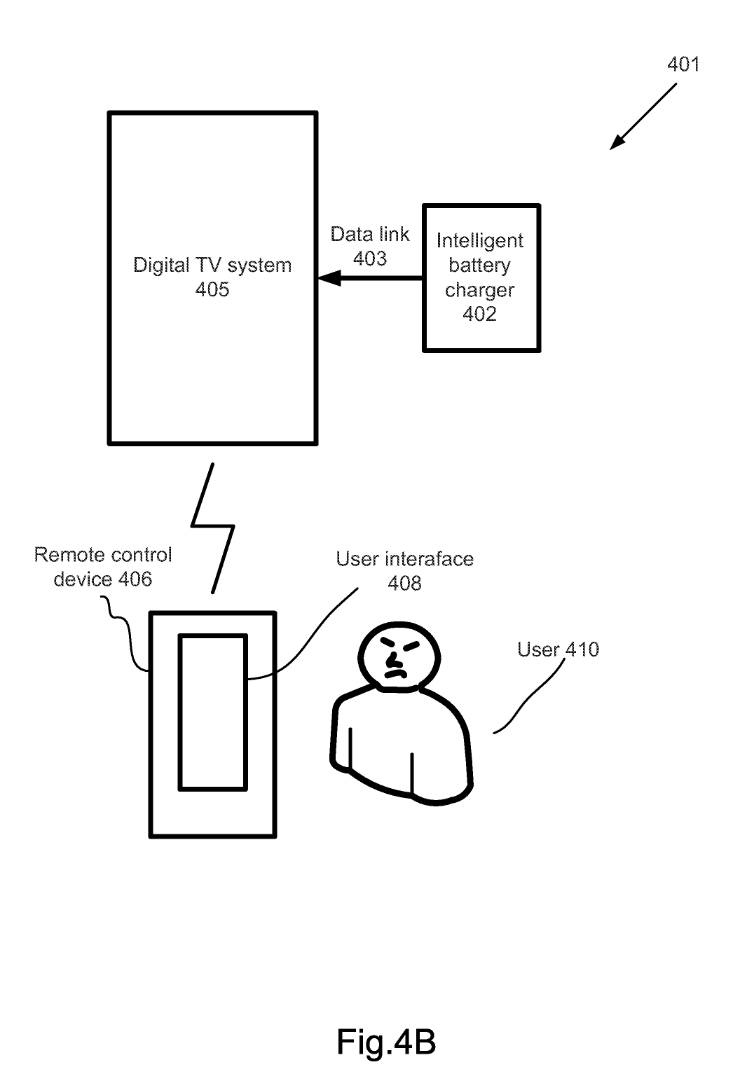

FIG. 4A is a schematic diagram illustrating an exemplary media delivery unit 400. The media delivery system 400 comprises an intelligent battery charger 402 and a HiFi audio system 404. They are connected through a data link 403. The intelligent battery charger 404 includes a media asset database. The HiFi audio system 404 may receive metadata of the media assets stored in 402 through the data link 403. In an exemplary implementation, the HiFi audio system 404 transmits the received metadata to the remote control device 406 and displays the user selectable media assets through a user interface 408 in a display screen of the remote control device 406. The user 410 selects at least one media asset. Upon the user's selection, the HiFi audio system 404 receives the user's instruction. The intelligent battery charger 402 then transfers the selected media asset to the HiFi audio system. The received media asset by the HiFi audio system 404 is streamed.

According to another implementation, the remote control device 406 is one of the personal electronic devices. For example, the remote control is the handheld media player. The databases in the intelligent battery charger 402 and the remote control device 406 have been synchronized before the charger 402 is connected to the HiFi audio system 404. In the exemplary case, the handheld media player can be used as the remote control device for the user to select a media asset to be streamed by the media delivery unit 404. There is no need to transfer metadata from the charger 402 to the remote control device 406 through the media delivery unit 404.

FIG. 4B illustrates another exemplary media delivery system 401. A video or a multimedia asset stored in the intelligent battery charger 402 may be delivered by using a digital TV system 405. Metadata of the video or the multimedia assets may be transmitted to the digital TV system 405 and subsequently to the remote control device 406. The user 410 selects a video asset through the use interface 408. The video asset is transmitted to the digital TV system 405 from the charger 402 and is streamed accordingly.

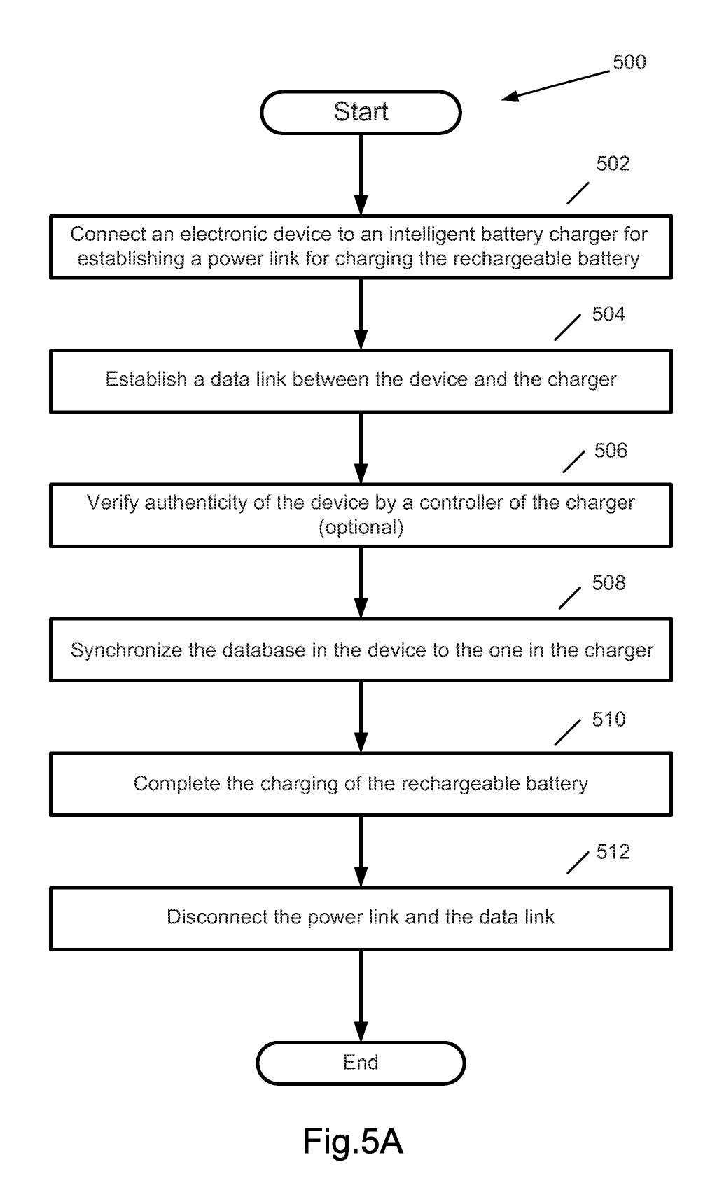

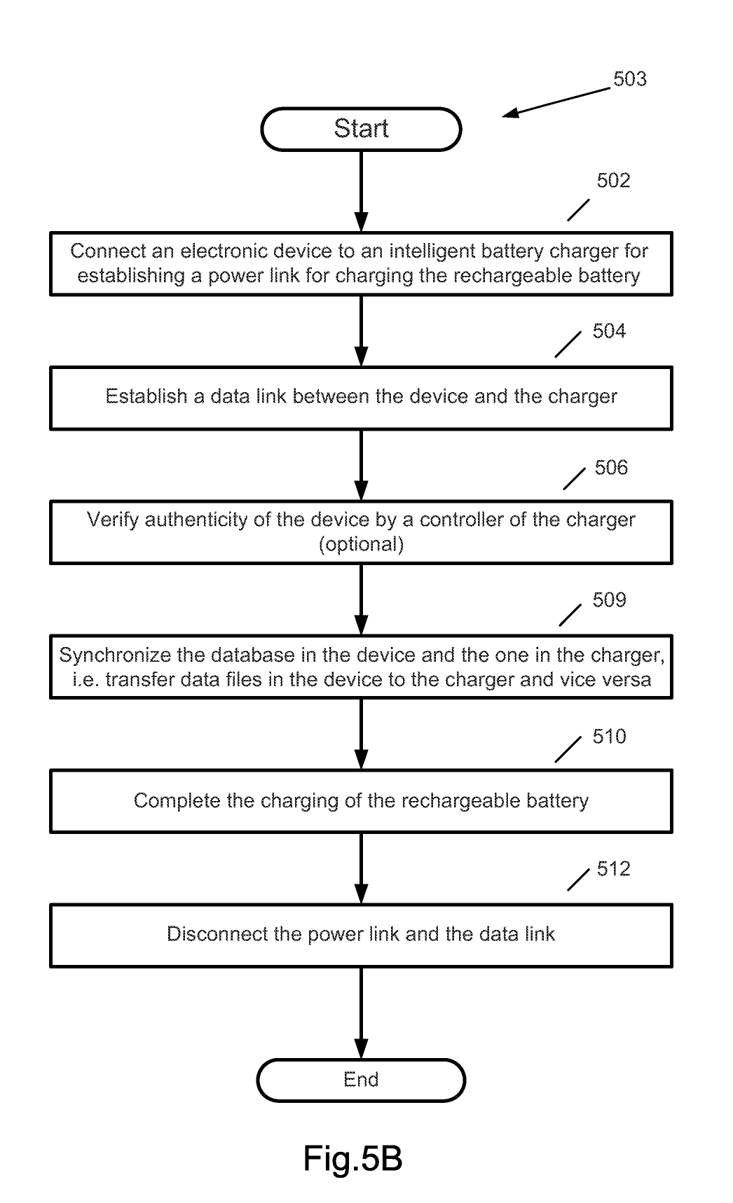

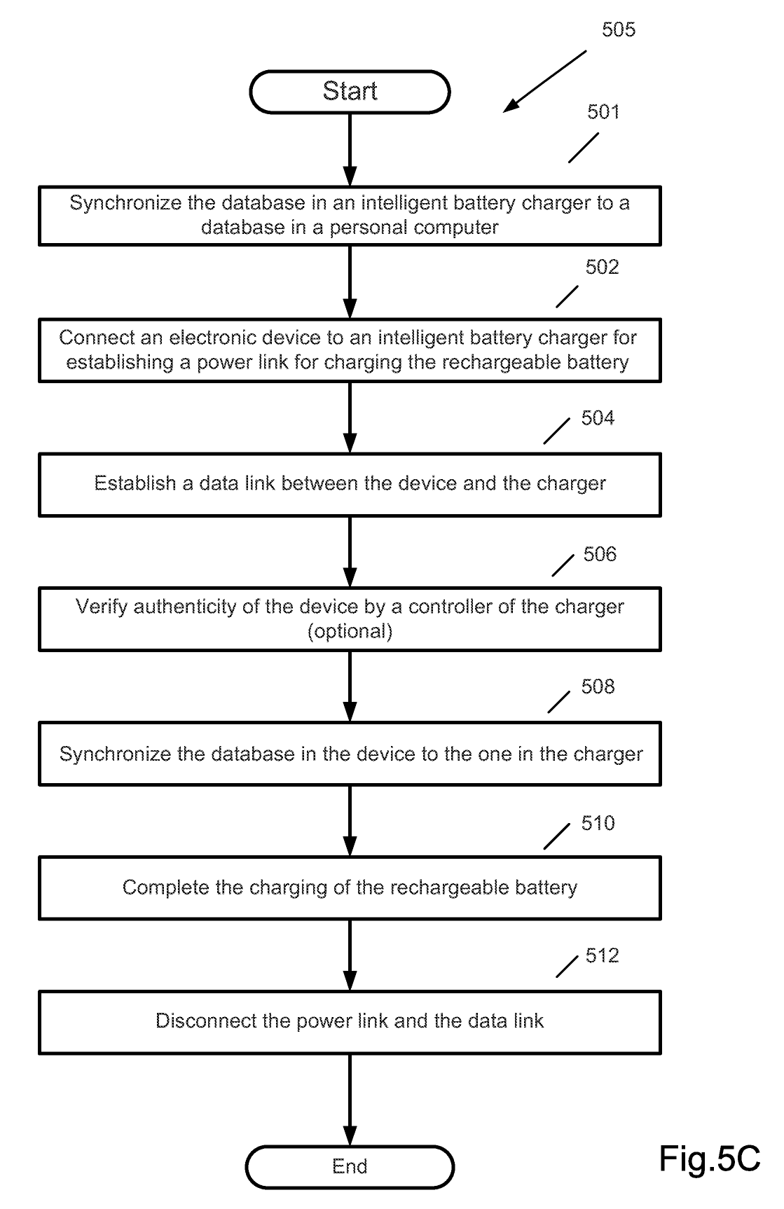

FIG. 5A is a flowchart illustrating an exemplary process 500 that database in the electronic device 104 is synchronized to the database in the intelligent battery charger 102. Process 500 starts with step 502 that a power link 108 is established between the electronic device 104 and the intelligent battery charger 102. The electrical power is delivered through the power link 108 to charge the rechargeable battery in the electronic device 104. In step 504, a data link 110 is established between the electronic device 104 and the charger 102. The data link 110 may include a USB type of connection. The data link 110 may also include a FIREWIRE (IEEE 1394) type of connection.

After the device 104 and the charger 102 are connected through the data link 110, authenticity of the device 104 may be checked by a controller in the charger 102 in step 506 optionally. Methods of checking the authenticity of a device is well established in the art. For example, the electronic device 104 may display a user interface and ask for the user to key in a password. The authenticity may also be verified by using biometric data such as fingerprints of the user. The authenticity check may be a one-time event. After the authenticity of the electronic device 104 is verified at the first time the device 104 and the charger 102 are connected, the controller of the charger 102 memorizes the device. No authenticity check is required in subsequently connecting events.

In step 508, the database in the electronic device 104 is synchronized to the one in the charger 102. After the completion of the step 508, the data link 110 may be disconnected. In step 510, the rechargeable battery is fully charged. In step 512, the power link 108 is disconnected.

FIG. 5B is a flowchart illustrating another exemplary process 503 that database in the electronic device 104 is synchronized to the database in the intelligent battery charger 102. Process 503 is identical to the process 500 except that the step 508 is replaced by step 509. In the step 509, the database in the electronic device 104 and the one in the charger 102 are synchronized to each other. After the data link 110 is established in step 504, the controller in the charger 102 or the controller in the electronic device 104 compares the data files stored in two databases. The controller starts a data file transferring step that the files stored in the device 104 (not in charger 102) are transferred to the charger 102 and vice versa. After the completion of the step 509, data files stored in the databases are identical.

FIG. 5C is a flowchart illustrating yet another exemplary process 505 that the database in the electronic device 104 is synchronized to the database in the intelligent charger 102. The process 505 is identical to the process 500 except that the database in the charger 102 is synchronized to a database in a personal computer in step 501. By adding the step 501, the database in the electronic device 104 will be synchronized to the database in the personal computer in an indirect manner

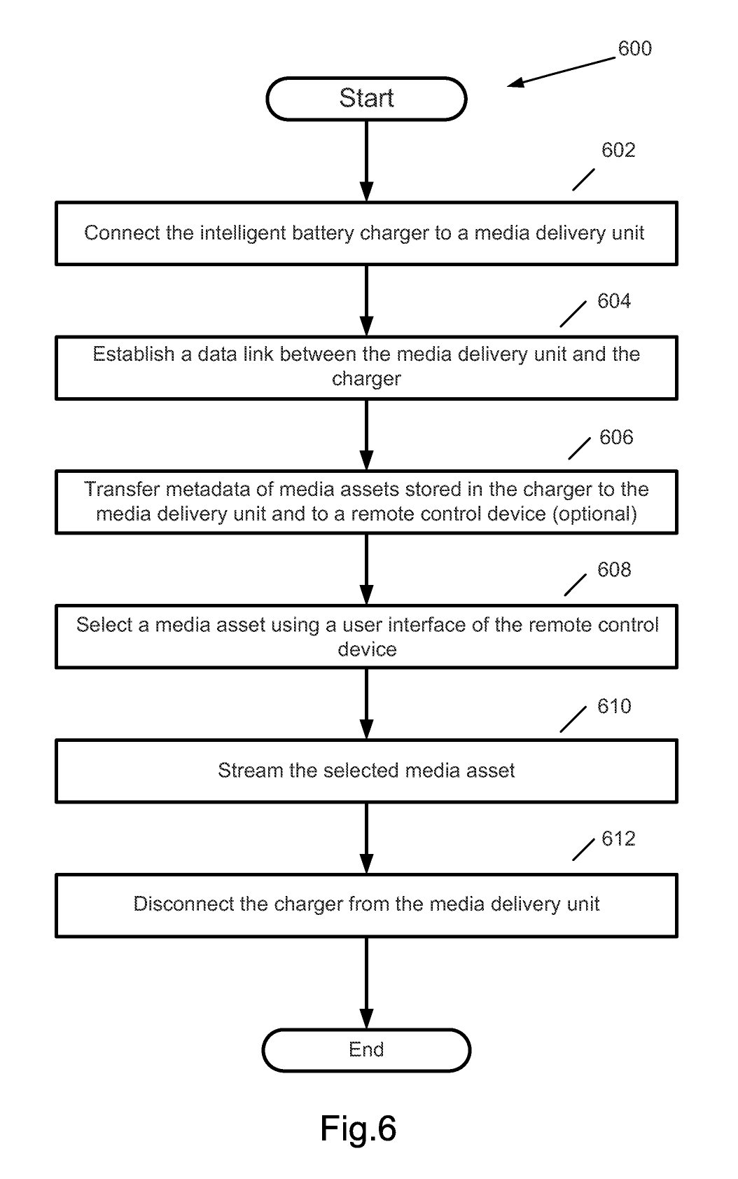

FIG. 6 is a flowchart illustrating an exemplary process 600 that a media asset is delivered to the user 410 by using a media delivery unit 404 connected to the intelligent charger 402. Process 600 starts with step 602 that the charger 402 and the media delivery unit 404 are connected. The data link 403 is established in step 604. The data link 403 may be a USB type of connection. The data link 430 may also be the FIREWIRE (IEEE 1394) type of connection. In step 606, the metadata of the media assets stored in the charger 402 is transferred from the charger 402 to the media delivery unit 404 and then to the remote control device 406. In step 608, a media asset is selected by the user through the user interface 408 of the remote control device 406. In step 610, the selected media asset is streamed using the media delivery unit 404 after the user's selection is received by the controller or the processor of the media delivery unit 404. The charger 402 is disconnected in step 612. The transmission of data in between the remote control device 406 and the media delivery unit 404 is accomplished by a wireless link. The link may be an optical link. The link may also be a short range communication link as known in the art.

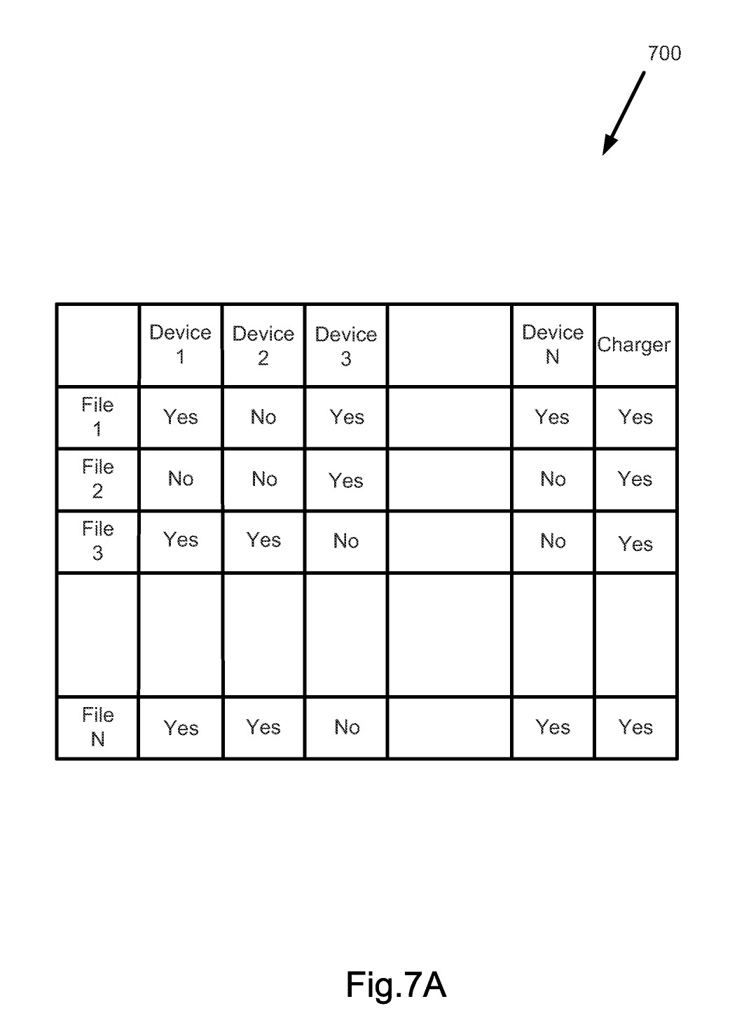

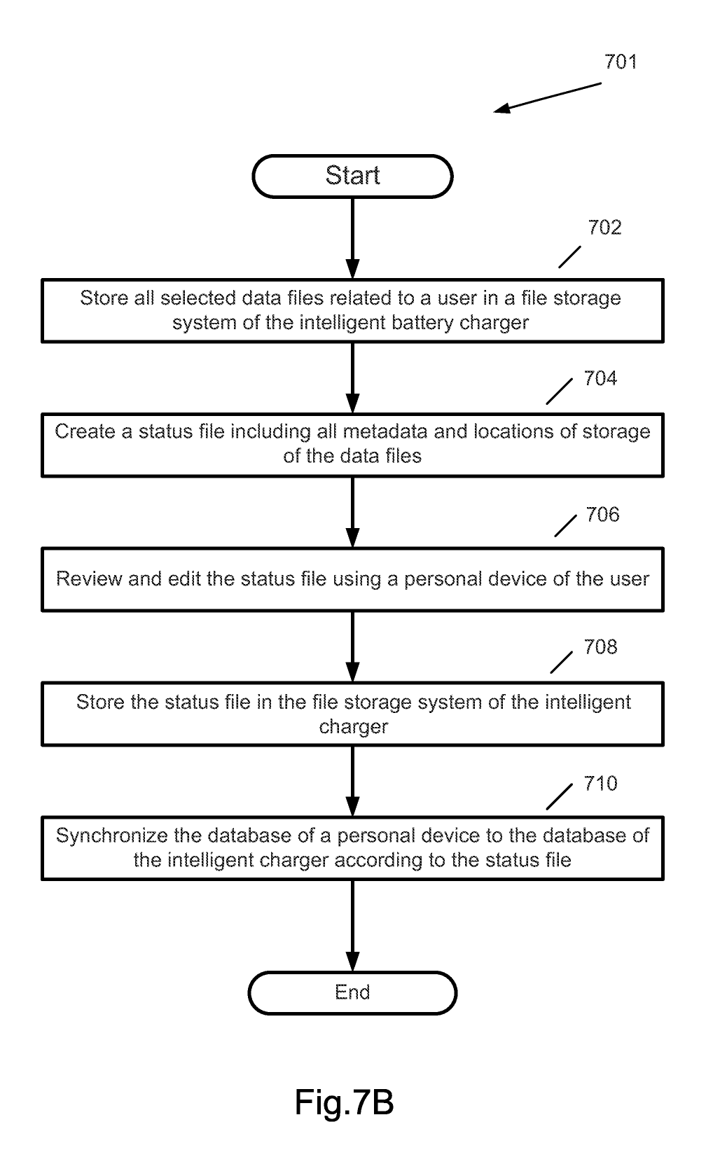

There may be a requirement that data files may be stored in different personal devices in a selective manner. FIG. 7A is an exemplary status file 700 indicating storage locations of multiple data files. According to one implementation of the present invention, the status file 700 is stored in the intelligent battery charger 102. According to another implementation, the status file 700 may also be stored in one or more personal devices. The user may employ one of the personal devices to edit the status file 700 to modify storage locations of the data files.

FIG. 7B is a flowchart illustrating process 701 that databases in the electronic devices and in the intelligent battery charger are synchronized based upon a status file. Process 701 starts with step 702 that all selected data files related to a user are stored in the intelligent battery charger 102. In step 704, a status file is created by the controller in the personal device 104 after the data link 110 is established between the charger 102 and the personal device 104. In step 706, the status file is reviewed and edited by the user of the personal device 104. In step 708, the status file is transferred to the charger 102 and is stored in the file storage system of the charger 102. In step 710, the database in the personal device 104 and the database in the charger 102 are synchronized according to the status file.

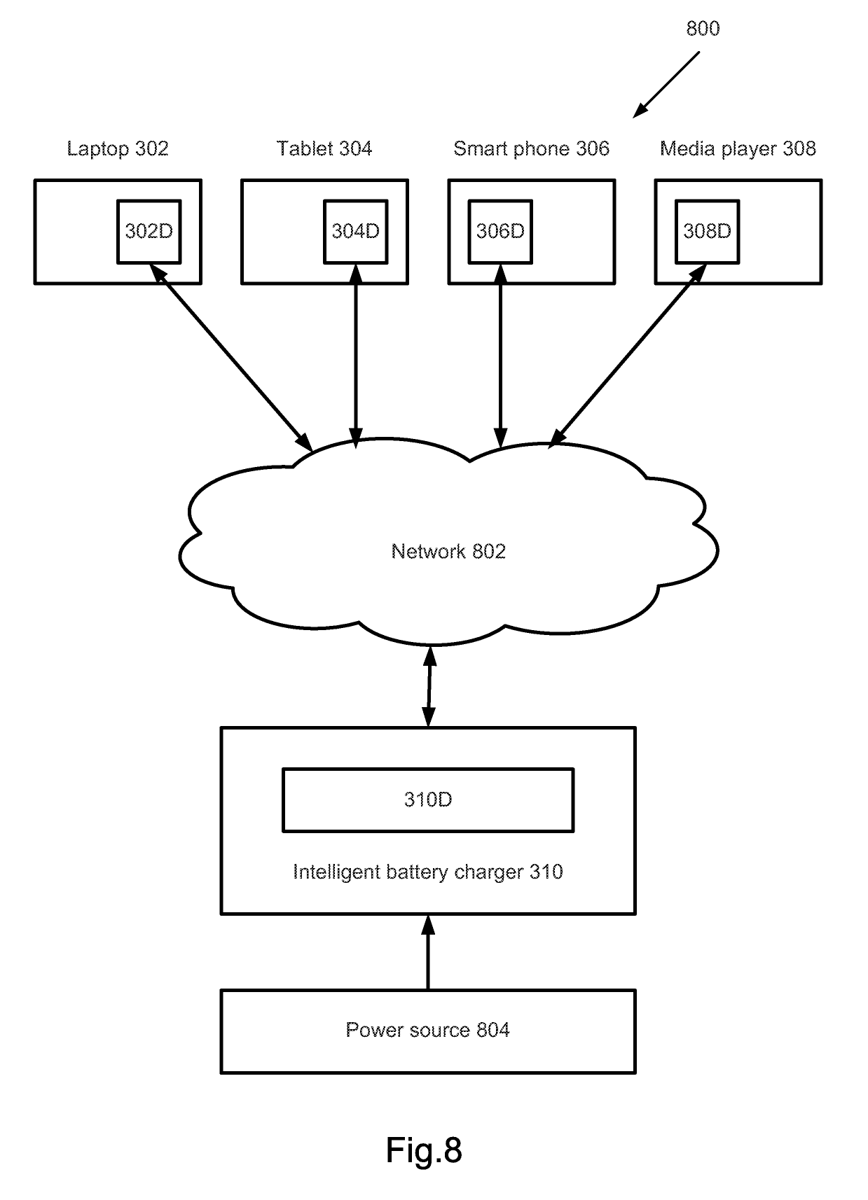

FIG. 8 is a schematic diagram illustrating another embodiment that personal electronic devices 302, 304, 306 and 308 may be connected to the intelligent battery charger 310 through a network 802. The network 802 is the Internet in an exemplary case. The intelligent charger 310 is connected to a power source 804 to supply the power for its operations. The databases 302D, 304D, 306D and 308D may be synchronized to the database 310D through the network 802.

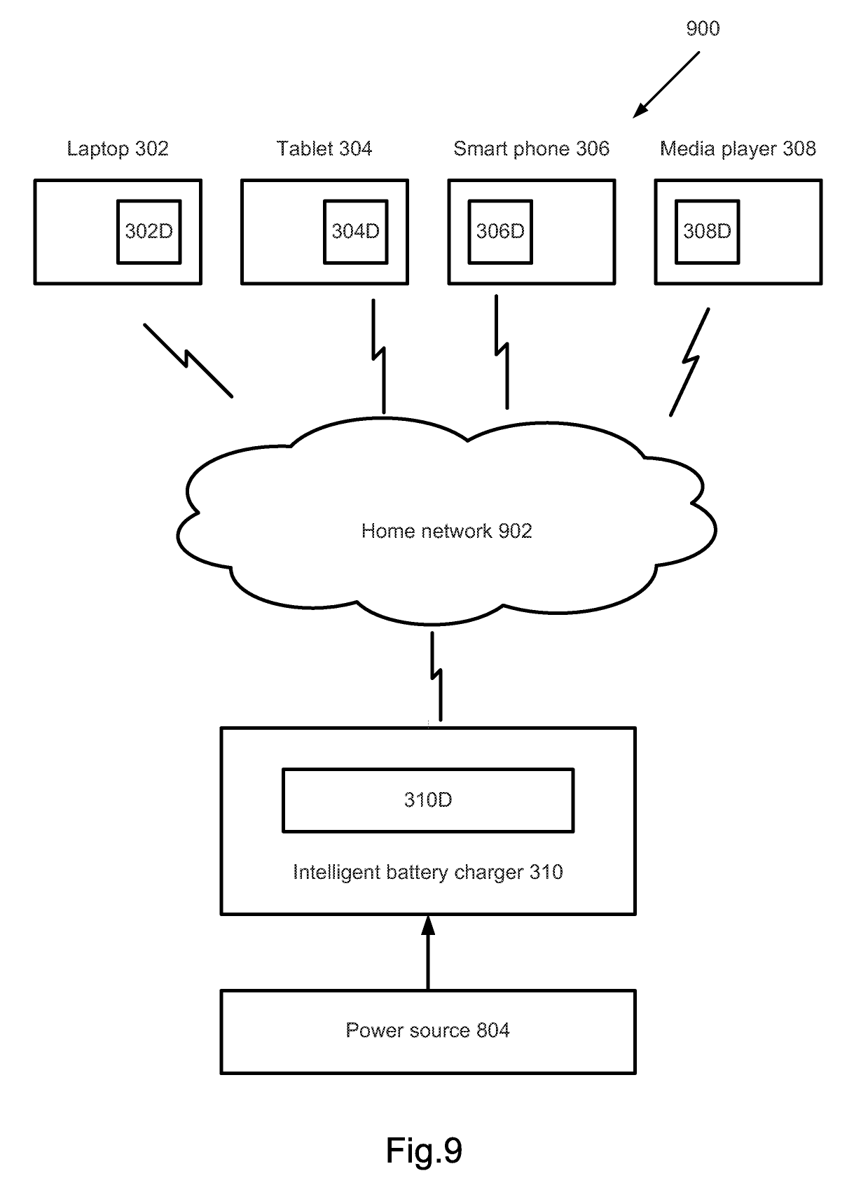

FIG. 9 is a schematic diagram illustrating another embodiment that personal electronic devices 302, 304, 306 and 308 may be connected to the intelligent battery charger 310 through a home network 902. The home network 902 is an ad hoc network in an exemplary case. The ad hoc network may be a Bluetooth type of connection according to one implementation. The ad hock network may be a ZigBee type of connection according to another implementation. The intelligent charger 310 is connected to a power source 804 to supply the power for operations of the intelligent charger 310. The databases 302D, 304D, 306D and 308D may be synchronized to the database 310D through the home network 902. The home network 902 may also be a LAN or a PAN.

According to another implementation, some of the databases may be synchronized when the rechargeable batteries devices are being charged while some other databases may be synchronized through the network 802 or the home network 902.

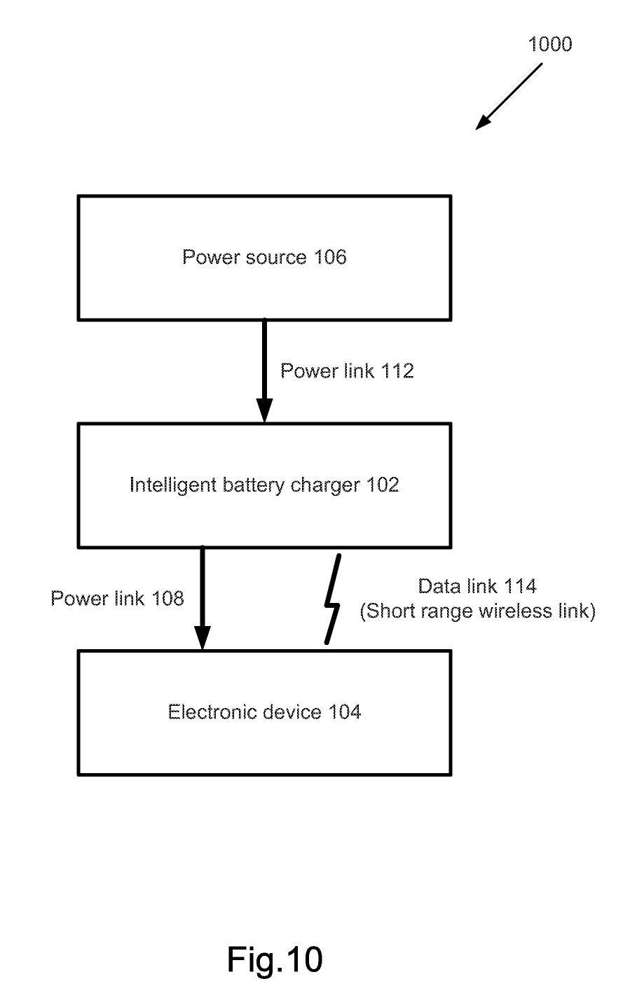

FIG. 10 is a schematic diagram illustrating another embodiment of the present invention. The exemplary system 1000 establishes a wireless data link 114 when the intelligent battery charger 102 is connected to the electronic device 104 by establishing a power link 108. The wireless data link 114 is a short range wireless communication link including but not limited to a Bluetooth type of link, a ZigBee type of link, a Wi-Fi type of link and a NFC type of link.

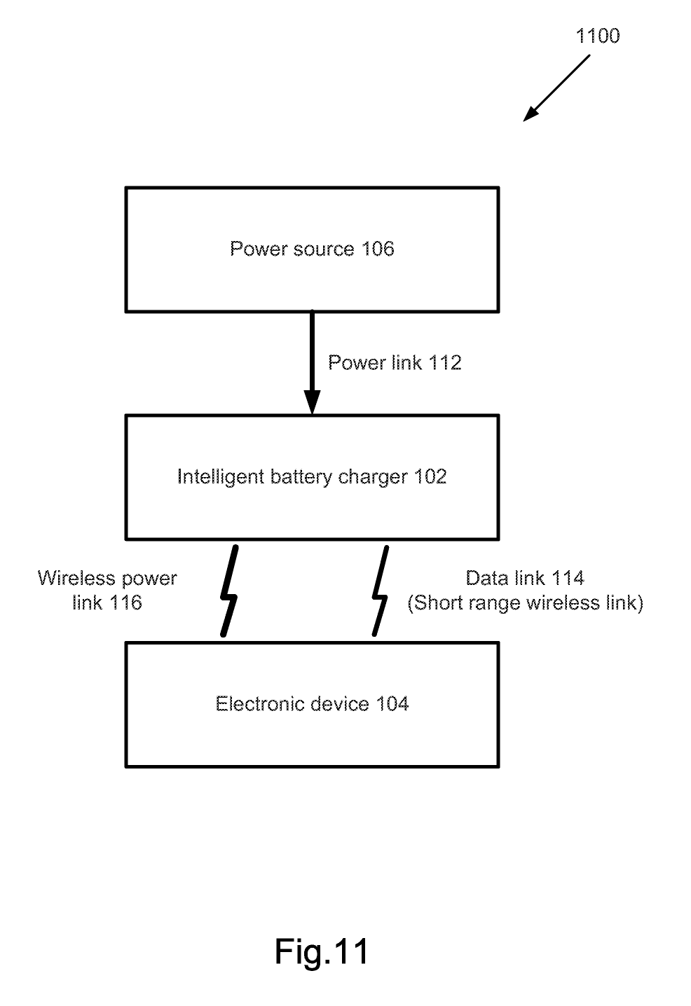

FIG. 11 is a schematic diagram illustrating yet another embodiment of the present invention. The exemplary system 1100 includes a wireless power link 116 and a wireless data link 114. According to the embodiment, the rechargeable battery in the electronic device 104 is charged in a wireless manner such as through a wireless RF power transmission. The databases are synchronized through the short range communication links.

1. An electronic system, comprising:
(a) one or a plurality of electronic devices, each including a file storage system with at least one database, a controller, a communication device, a connector and a rechargeable battery; and
(b) a battery charger including a file storage system with at least one database, a communication device and a connector,
wherein said database of said battery charger further includes a plurality of data files, wherein said databases of the electronic devices are synchronized to said database of said battery charger after said devices are connected to said battery charger for charging said rechargeable batteries.

2. The electronic system as recited in claim 1, wherein said battery charger and said electronic device are connected through a power link established by said connectors for delivering electrical power to charge the rechargeable battery and through a data link established by said communication devices for transferring data files.

3. The electronic system as recited in claim 2, wherein said data link further comprising a wired or a wireless link.

4. The electronic system as recited in claim 3, wherein said wired link further comprising one or a combination of followings:
(a) a USB type of connection; and
(b) a FIREWIRE type of connection.

5. The electronic system as recited in claim 3, wherein said wireless link further comprising one or a combination of followings:
(a) a Bluetooth type of connection;
(b) a ZigBee type of connection;
(c) a Wi-Fi type of connection; and
(d) a NFC type of connection.

6. The electronic system as recited in claim 1, wherein said data files in said battery chargers are transferred from a database of a personal computer.

7. The electronic system as recited in claim 1, wherein said battery charger is connectable to a media delivery unit and said data files stored in said battery charger further comprising media assets and said media assets may be delivered to a user through said media delivery unit.

8. The electronic system as recited in claim 7, wherein said system further comprising a remote control device, wherein said remote control device further including a database that has been synchronized to said database in said battery charger.

9. The electronic system as recited in claim 7, wherein said media assets stored in said battery charger further comprising a data file including metadata of media assets, wherein said data file may be transferred to the media delivery unit and subsequently to a remote control device of the media delivery unit.

10. The electronic system as recited in claim 1, wherein said battery charger further comprising a controller for controlling data transferring between said electronic devices and said battery charger.

11. The electronic system as recited in claim 1, wherein said battery charger is connectable to a network, said network including the Internet and a home network.

12. The electronic system as recited in claim 10, wherein said data files stored in the battery charger are accessible by the electronic device through said networks.

13. A method of managing data files, comprising:
(a) generating a database including a plurality of data files in a file storage system of a battery charger;
(b) connecting an electronic device to the battery charger for charging a rechargeable battery of the device;
(c) establishing a data link between the device and the charger; and
(d) synchronizing a database in the electronic device to said database of said battery charger, said data files further including media assets.

14. The method as recited in claim 13, wherein said method further comprising transferring data files in between said electronic device and said battery charger according to a set of predetermined rules.

15. The method as recited in claim 14, wherein said predetermined rules are defined by a status file, wherein said status file further including storage locations of each said data file, wherein said status file is editable by a user through a personal device.

16. The method as recited in claim 13, wherein said method further comprising verifying authenticity of the connected electronic device by a controller in said battery charger.

17. The method as recited in claim 13, wherein said data link further including a wired link and a wireless link.

18. The method as recited in claim 13, wherein said method further comprising transferring said data files from the battery charger to the electronic device or vice versa through a network, said network including the Internet and a home network.

19. A method of managing data files, comprising:
(a) storing a plurality of data files in a file storage system of a battery charger;
(b) connecting an electronic device to the battery charger for charging a rechargeable battery of the device;
(c) establishing a data link between the device and the charger; and
(d) transferring data files in between said device and said charger according to a status file, said status file further including storage locations for each said data files.

20. The method as recited in claim 19, wherein said status file may be stored in said file storage system of said battery charger or in said electronic device, wherein said status file is editable by a user through a user interface of the electronic device.
